(19) United States
(12) Patent Application Publication
(10) Pub. No.: US 2010/0209703 A1
(43) Pub. Date: Aug. 19, 2010

(54) DOUBLE-SIDED PRESSURE-SENSITIVE ADHESIVE SHEET AND PRESSURE-SENSITIVE ADHESIVE TYPE OPTICAL MEMBER

(75) Inventors: Shou TAKARADA, Osaka (JP); Hiroaki KISHIOKA, Osaka (JP); Tomohide BANBA, Osaka (JP); Takahiro NONAKA, Osaka (JP)

Correspondence Address: SUGHRUE-265550, 2100 PENNSYLVANIA AVE. NW, WASHINGTON, DC, 20037-3213, US

(73) Assignee: NITTO DENKO CORPORATION, Ibaraki-shi (JP)

(21) Appl. No.: 12/705,998

(22) Filed: Feb. 16, 2010

(30) Foreign Application Priority Data
Feb. 18, 2009 (JP) 2009-035058

(51) Int. Cl. B32B 7/12

(52) U.S. Cl. 428/355 AC; 428/343

(57) ABSTRACT

The present invention provides a double-sided pressure-sensitive adhesive sheet, including at least one pressure-sensitive adhesive layer which has a gel fraction of 10 to 70%, has a storage modulus at 23° C. of 1×10⁵ Pa or less, and has a residual stress after 180 seconds of 3.5 N/cm² or less, the storage modulus at 23° C. being measured in accordance with a dynamic viscoelasticity measurement and the residual stress after 180 seconds being measured in accordance with a tensile stress relaxation test under conditions of a temperature of 23° C. and a strain of 300%.

### FIELD OF THE INVENTION

The present invention relates to a double-sided pressure-sensitive adhesive sheet. In addition, it also relates to a pressure-sensitive adhesive type optical member using the double-sided pressure-sensitive adhesive sheet.

### BACKGROUND OF THE INVENTION

Recently, in various fields, display devices such as a liquid crystal display (LCD) and input devices such as a touch panel to be used in combination with the above display devices have been widely used. In the production of these display devices and input devices, a transparent pressure-sensitive adhesive sheet is used in applications for optical member adhesion. For example, a transparent double-sided pressure-sensitive adhesive sheet is used for adhering a touch panel or the like and a liquid crystal display device (see, e.g., Patent Documents 1 to 3).

Among the optical members, those containing a member having thickness unevenness such as printed thickness unevenness have increased. For example, there is a case where a lens member having a flame-shaped printing applied thereto is adhered on a liquid crystal display device through a double-sided pressure-sensitive sheet. In such a case, there is a possibility that a local stress may be exerted on the product resulting from the printed thickness unevenness and thereby unevenness (irregularity) in optical properties may occur in some cases. Therefore, in such applications, a stress relaxation property is required for the pressure-sensitive adhesive sheet together with an ability to adhere and fix the member.

Moreover, in the applications of adhering optical member as mentioned above, particularly for the pressure-sensitive adhesive sheet, not only adhesiveness and transparency, but also excellent reliability such as properties of generating no foaming or peeling (foaming resistance and peeling resistance, also referred to as foaming/peeling resistance) under a high-temperature or high-humidity environment is required.

Patent Document 1: JP-A-2003-238915

Patent Document 2: JP-A-2003-342542

Patent Document 3: JP-A-2004-231723

### SUMMARY OF THE INVENTION

An object of the invention is to provide a double-sided pressure-sensitive adhesive sheet excellent in stress relaxation property. Owing to the excellent stress relaxation property, display unevenness (unevenness in optical properties) can be suppressed. Furthermore, another object of the invention is to provide a double-sided pressure-sensitive adhesive sheet also excellent in foaming/peeling resistance.

As a result of intensive studies for achieving the above objects, the present inventors have found that a double-sided pressure-sensitive adhesive sheet excellent in stress relaxation property can be obtained by making a double-sided pressure-sensitive adhesive sheet having at least one pressure-sensitive adhesive layer which is designed so that a gel fraction, storage modulus measured in accordance with dynamic viscoelasticity test, and residual stress measured in accordance with tensile stress relaxation test are each controlled to a specific range. The invention has been completed based on these findings.

Namely, the present invention provides the following items 1 to 7.

1. A double-sided pressure-sensitive adhesive sheet, comprising at least one pressure-sensitive adhesive layer which has a gel fraction of 10 to 70%, has a storage modulus at 23° C. of 1×10⁵ Pa or less, and has a residual stress after 180 seconds of 3.5 N/cm² or less, the storage modulus at 23° C. being measured in accordance with a dynamic viscoelasticity measurement and the residual stress after 180 seconds being measured in accordance with a tensile stress relaxation test under conditions of a temperature of 23° C. and a strain of 300%.

2. The double-sided pressure-sensitive adhesive sheet according to item 1, wherein the pressure-sensitive adhesive layer is an acrylic pressure-sensitive adhesive layer.

3. The double-sided pressure-sensitive adhesive sheet according to item 2, wherein the acrylic pressure-sensitive adhesive layer is an acrylic pressure-sensitive adhesive layer formed using a (meth)acrylic acid alkyl ester and an acrylic acid alkoxyalkyl ester as essential monomer components.

4. The double-sided pressure-sensitive adhesive sheet according to item 3, wherein the acrylic pressure-sensitive adhesive layer is an acrylic pressure-sensitive adhesive layer formed by irradiating with an active energy ray a composition containing a monomer mixture containing a (meth)acrylic acid alkyl ester and an acrylic acid alkoxyalkyl ester as essential monomer components or a partial polymerization product thereof, and wherein the monomer mixture contains the acrylic acid alkoxyalkyl ester in an amount of 10 to 45% by weight.

5. The double-sided pressure-sensitive adhesive sheet according to item 1, which is a substrate-less double-sided pressure-sensitive adhesive sheet consisting of the pressure-sensitive adhesive layer.

6. The double-sided pressure-sensitive adhesive sheet according to item 1, which has a total thickness of 50 to 600 μm.

7. A pressure-sensitive adhesive type optical member, which comprises an optical member and the double-sided pressure-sensitive adhesive sheet according to item 1 laminated on a surface of the optical member.

The double-sided pressure-sensitive adhesive sheet of the invention is excellent in stress relaxation property, since the gel fraction of the pressure-sensitive adhesive layer, storage modulus thereof, and residual stress upon stress relaxation thereof each falls within a specific range. Therefore, even when the sheet is adhered to a member having thickness unevenness, exertion of a local stress caused by the thickness unevenness on the adherend is relaxed and thus uneven stress which is caused by the thickness unevenness and is exerted on the adherend decreases. Accordingly, for example, in the case where the sheet is applied to an optical member, heterogeneity in optical properties and the like resulting from the uneven stress do not occur. Therefore, there arises no inconvenience such as display unevenness on the optical products obtained. Moreover, by using an acrylic pressure-sensitive adhesive layer formed from monomer components having a specific composition as the pressure-sensitive adhesive layer, foaming/peeling resistance is particularly improved and thus lifting and peeling from the adherend can be prevented or suppressed even under a high-temperature and high-humidity environment. Accordingly, the sheet is particularly useful in applications such as optical members.

### BRIEF DESCRIPTION OF THE DRAWING

FIG. 1 is a schematic view (cross-sectional view) showing a test piece in the evaluation method for foaming/peeling resistance.

### DESCRIPTION OF REFERENCE NUMERALS AND SIGNS

1 test piece
2 glass plate
3 polarizing plate
4 double-sided pressure-sensitive adhesive sheet
5 polymethyl methacrylate (PMMA) plate (MR-200)

### DETAILED DESCRIPTION OF THE INVENTION

The double-sided pressure-sensitive adhesive sheet of the invention is a double-sided pressure-sensitive adhesive sheet having at least one pressure-sensitive adhesive layer (hereinafter sometimes referred to as a “pressure-sensitive adhesive layer of the invention”) where a gel fraction is 10 to 70%, storage modulus at 23° C. measured by a dynamic viscoelasticity measurement is less than 1×10⁵ Pa, and residual stress after 180 seconds measured by a tensile stress relaxation test under conditions of a temperature of 23° C. and a strain of 300% is 3.5 N/cm² or less, the both sides thereof being pressure-sensitive adhesive surfaces (pressure-sensitive adhesive layer surfaces). Incidentally, in the invention, the “double-sided pressure-sensitive adhesive sheet” includes any form of tape-form one and sheet-form one, i.e., is a generic term including a double-sided pressure-sensitive adhesive sheet and a double-sided pressure-sensitive adhesive tape.

The double-sided pressure-sensitive adhesive sheet of the invention may be a so-called “substrate-less type” double-sided pressure-sensitive adhesive sheet having no substrate (substrate layer) (hereinafter sometimes referred to as “substrate-less pressure-sensitive adhesive sheet”) or may be a substrate-attached type double-sided pressure-sensitive adhesive sheet. The above-mentioned substrate-less double-sided pressure-sensitive adhesive sheet may be a double-sided pressure-sensitive adhesive sheet composed only of (consisting of) the pressure-sensitive adhesive layer of the invention or may be a double-sided pressure-sensitive adhesive sheet including the pressure-sensitive adhesive layer of the invention and a pressure-sensitive adhesive layer other than the pressure-sensitive adhesive layer of the invention (hereinafter sometimes referred to as “other pressure-sensitive adhesive layer”). Moreover, it is sufficient that the substrate-attached type double-sided pressure-sensitive adhesive sheet includes the pressure-sensitive adhesive layer of the invention at least on one side of the substrate. In particular, from the viewpoint of improving optical properties such as transparency in the case of the use in optical applications, the substrate-less double-sided pressure-sensitive adhesive sheet is preferred, and more preferred is a substrate-less double-sided pressure-sensitive adhesive sheet composed only of (consisting of) the pressure-sensitive adhesive layer of the invention. In this regard, the above-mentioned “substrate (substrate layer)” does not include a release liner (separator) to be peeled off at the time when the pressure-sensitive adhesive sheet is used (at the time of adhesion).

The gel fraction of the pressure-sensitive adhesive layer of the invention is 10 to 70% (in terms of % by weight), preferably 20 to 70% from the viewpoint of improving the stress relaxation property. The gel fraction can be determined as an ethyl acetate-insoluble content and specifically, can be determined as a weight fraction (unit: % by weight) of the insoluble content after immersion in ethyl acetate at 23° C. for 7 days relative to the sample before immersion. When the gel fraction is less than 10%, processability decreases and, for example, there occurs “paste run-off” which is a phenomenon that the pressure-sensitive adhesive layer is deformed and run off from the edge of the adherend in the case where the sheet is pasted to the adherend. On the other hand, when the gel fraction exceeds 70%, the stress relaxation property decreases.

According to the present invention, the above-mentioned gel fraction (ratio of the solvent-insoluble content) is specifically a value calculated by the following “Measuring Method of Gel Fraction”.

(Measuring Method of Gel Fraction)

The pressure-sensitive adhesive layer: about 0.1 g is collected from the double-sided pressure-sensitive adhesive sheet of the invention. After the layer is wrapped in a porous tetrafluoroethylene sheet (product name “NTF1122”, manufactured by Nitto Denko Corporation) having an average pore diameter of 0.2 μm, it is tied with a kite string and the weight at that time is measured, the weight being regarded as weight before immersion. Incidentally, the weight before immersion is total weight of the pressure-sensitive adhesive layer (pressure-sensitive adhesive layer of the invention collected as above), the tetrafluoroethylene sheet, and the kite string. Moreover, total weight of the tetrafluoroethylene sheet and the kite string is also measured and the eight is regarded as tare weight.

Next, the above-mentioned material obtained by wrapping the pressure-sensitive adhesive layer in the tetrafluoroethylene sheet and tying it with the kite string (referred to as a “sample”) is placed in a 50 ml vessel filled with ethyl acetate and allowed to stand at 23° C. for 7 days. Thereafter, the sample (after the treatment with ethyl acetate) is taken out of the vessel and transferred to an aluminum cup. After the sample was dried at 130° C. for 2 hours in a drier to remove ethyl acetate, weight thereof was measured, the weight being regarded as weight after immersion.

Then, the gel fraction is calculated according to the following formula:

Gel Fraction (% by weight)=(A−B)/(C−B)×100 (1)

(wherein A is weight after immersion, B is tare weight, and C is weight before immersion).

The storage modulus at 23° C. of the pressure-sensitive adhesive layer of the invention (hereinafter sometimes referred to as “storage modulus (23° C.)” or “G′ (23° C.)”) measured by a dynamic viscoelasticity measurement is 1.0×10⁵ Pa or less, preferably from 1.0×10⁴ Pa to 1.0×10⁵ Pa, and more preferably 4.0×10⁴ Pa to 9.0×10⁴ Pa. When the storage modulus (23° C.) exceeds 1.0×10⁵ Pa, the residual stress of the pressure-sensitive adhesive layer tends to increase and the stress relaxation property of the double-sided pressure-sensitive adhesive sheet decreases, so that the display unevenness is apt to occur. When the storage modulus (23° C.) is less than 1.0×10⁴ Pa, processability decreases in some cases. In this regard, the above-mentioned residual stress is influenced by not only the storage modulus and the loss modulus to be mentioned later but also the monomer composition of the polymer constituting the pressure-sensitive adhesive layer and the like.

Incidentally, according to the present invention, the above-mentioned storage modulus is measured by the following dynamic viscoelasticity measurement. Specifically, the storage modulus can be measured by laminating a plurality of the pressure-sensitive adhesive layers so as to be a thickness of about 1.5 mm and determining the modulus by using “Advanced Rheometric Expansion System (ARES)” manufactured by Rheometric Scientific under the conditions of a frequency of 1 Hz in the temperature range of −70 to 200° C. at a temperature-elevating rate of 5° C./minute at a shear mode.

The loss modulus at 23° C. of the pressure-sensitive adhesive layer of the invention (hereinafter sometimes referred to as “loss modulus (23° C.)” or “G” (23° C.)”) measured by a dynamic viscoelasticity measurement is 1.0×10⁴ Pa to 1.0×10⁵ Pa, preferably 1.0×10⁴ Pa to 9.0×10⁴ Pa. When the loss modulus (23° C.) exceeds 1.0×10⁵ Pa, the residual stress of the pressure-sensitive adhesive layer tends to increase and the stress relaxation property of the double-sided pressure-sensitive adhesive sheet decreases, so that the display unevenness is apt to occur in some cases. When the loss modulus (23° C.) is less than 1.0×10⁴ Pa, processability decreases in some cases. According to the present invention, the above-mentioned loss modulus is measured by the dynamic viscoelasticity measurement similar to the case of the storage modulus.

The residual stress after 180 seconds of the pressure-sensitive adhesive layer of the invention measured by a tensile stress relaxation test under the conditions of a temperature of 23° C. and a strain of 300% (hereinafter sometimes simply referred to as “residual stress”) is 3.5 N/cm² or less, preferably 0.1 to 2.5 N/cm², more preferably 0.1 to 2 N/cm², and further preferably 0.1 to 1.9 N/cm². When the residual stress exceeds 3.5 N/cm², the stress relaxation property of the double-sided pressure-sensitive adhesive sheet decreases and thus the display unevenness is apt to occur.

Incidentally, according to the present invention, the above-mentioned residual stress is measured by the following tensile stress relaxation test. Specifically, using a tensile tester, a measuring sample (pressure-sensitive adhesive layer) is drawn under an environment of 23° C. until strain (elongation) reaches 300% (drawing rate: 200 m/minute), the strain is kept, and stress (tensile stress) (N/cm²) after 180 seconds have passed from completion of the drawing is measured, the stress being able to be regarded as the residual stress. More specifically, the measurement can be performed by the method described in “(2) Tensile Stress Relaxation Test [Residual Stress]” in (Evaluation) to be mentioned later.

The tensile stress of the pressure-sensitive adhesive layer of the invention at a temperature of 23° C. at a strain (elongation) of 300% (hereinafter sometimes referred to as “300% tensile stress”) is preferably 6 N/cm² or less, more preferably 0.5 to 5 N/cm². The above-mentioned 300% tensile stress is measured by the tensile stress relaxation test similar to the case of the above-mentioned residual stress. Specifically, using a tensile tester, a maximum stress (tensile stress) (N/cm²) is measured at the time when a measuring sample (pressure-sensitive adhesive layer) is drawn under an environment of 23° C. until strain (elongation) reaches 300% (drawing rate: 200 m/minute), the stress being able to be regarded as the 300% tensile stress. More specifically, the measurement can be performed by the method described in “(3) Tensile Stress Relaxation Test [300% Tensile Stress]” in (Evaluation) to be mentioned later.

In the double-sided pressure-sensitive adhesive sheet of the invention, the 180° peeling pressure-sensitive adhesive force at 23° C. of the surface of the pressure-sensitive adhesive layer of the invention with respect to an acrylic plate (hereinafter sometimes referred to as “180° peeling pressure-sensitive adhesive force (vs acrylic plate)”) is preferably 5 N/25 mm or more (e.g., 5 to 50 N/25 mm), more preferably 10 N/25 mm or more, and further preferably 15 N/25 mm or more. When the 180° peeling pressure-sensitive adhesive force (vs acrylic plate) is less than 5 N/25 mm, adhesion reliability decreases in some cases. In this regard, according to the present invention, the above-mentioned 180° peeling pressure-sensitive adhesive force (vs acrylic plate) can be measured by a 180° peeling test in which an acrylic plate is used as an adherend under the conditions of 23° C. and 50% RH. Specifically, in accordance with JIS Z 0237 and using “Acrylite” manufactured by Mitsubishi Rayon Co., Ltd. (thickness of 2 mm) as the adherend (test plate), the force can be measured by 180° peeling under the conditions of a drawing rate of 300 mm/minute after the surface of the pressure-sensitive adhesive layer of the invention in the double-sided pressure-sensitive adhesive sheet of the invention is adhered to the adherend. Incidentally, the measurement can be conducted after a backing material (a PET film, “Lumirror S-10” manufactured by Toray Industries, Inc., thickness of 25 μm) is adhered to the surface (pressure-sensitive adhesive surface) of the pressure-sensitive adhesive layer opposite to the measuring surface.

In the double-sided pressure-sensitive adhesive sheet of the invention, the 180° peeling pressure-sensitive adhesive force at 23° C. of the surface of the pressure-sensitive adhesive layer of the invention with respect to a polarizing plate (sometimes referred to as “180° peeling pressure-sensitive adhesive force (vs polarizing plate)”) is preferably 1 N/25 mm or more (e.g., 1 to 10 N/25 mm), more preferably 3 N/25 mm or more. When the 180° peeling pressure-sensitive adhesive force (vs polarizing plate) is less than 1 N/25 mm, adhesion reliability decreases in some cases. In this regard, according to the present invention, the above-mentioned 180° peeling pressure-sensitive adhesive force (vs polarizing plate) can be measured in a similar manner to the case of the above-mentioned 180° peeling pressure-sensitive adhesive force (vs acrylic plate) except that a polarizing plate (product name “TEG1465DUHC” manufactured by Nitto Denko Corporation, hard coated surface) is used as the adherend.

The pressure-sensitive adhesive layer of the invention preferably has a high transparency and, for example, total light transmittance in the visible light region (in accordance with JIS K 7361) is preferably 90% or more, more preferably 91% or more. Moreover, the haze value of the pressure-sensitive adhesive layer of the invention (in accordance with JIS K 7136) is, for example, preferably less than 1.0%, more preferably less than 0.8%. In this regard, according to the present invention, the total light transmittance and the haze value can be measured with adhering the pressure-sensitive adhesive layer of the invention to a slide glass (one having a total light transmittance of 91.8% and a haze value of 0.4%) and by using a haze meter (product name “HM-150”, manufactured by Murakami Color Research Laboratory Co., Ltd.).

In the double-sided pressure-sensitive adhesive sheet of the invention, since the gel fraction, the storage modulus (23° C.), and the residual stress of the pressure-sensitive adhesive layer are respectively within the above-described specific ranges, the pressure-sensitive adhesive layer is relatively soft under a room-temperature condition. Therefore, the thickness unevenness followability and the stress relaxation property are improved. Therefore, the display unevenness is difficult to occur.

In the case where the 180° peeling pressure-sensitive adhesive force (vs acrylic plate) of the surface at the side of the pressure-sensitive adhesive layer of the invention in the double-sided pressure-sensitive adhesive sheet of the invention falls within the above range, particularly at the time when the sheet is adhered to an acrylic plate, the sheet is hardly peeled off from the acrylic plate and is hardly foamed. Moreover, in the case where the 180° peeling pressure-sensitive adhesive force (vs polarizing plate) of the surface at the side of the pressure-sensitive adhesive layer of the invention in the double-sided pressure-sensitive adhesive sheet of the invention falls within the above range, particularly at the time when the sheet is adhered to a polarizing plate, the sheet is hardly peeled off from the polarizing plate and is hardly foamed.

The thickness of the pressure-sensitive adhesive layer of the invention is not particularly limited but is preferably 50 to 600 μM, more preferably 70 to 500 μm, and further preferably 70 to 250 μm. When the thickness of the pressure-sensitive adhesive layer is less than 50 μm, the sheet cannot follow the thickness unevenness in some cases. When the thickness exceeds 600 μm, the processability decreases in some cases. Incidentally, the pressure-sensitive adhesive layer of the invention may have either form of a monolayer or a laminate.

The total thickness of the double-sided pressure-sensitive adhesive sheet of the invention (thickness from one pressure-sensitive adhesive surface to the other pressure-sensitive adhesive surface) is not particularly limited but is preferably 50 to 600 μm, more preferably 70 to 500 μm, and further preferably 70 to 250 μm. When the total thickness of the double-sided pressure-sensitive adhesive sheet is less than 50 μm, the sheet cannot follow the thickness unevenness in some cases. When the thickness exceeds 600 μm, the processability decreases in some cases.

In the double-sided pressure-sensitive adhesive sheet of the invention, the pressure-sensitive adhesive layer of the invention may have a gel fraction of 10 to 70%, a storage modulus (23° C.) of 1×10⁵ Pa or less, and a residual stress of 3.5 N/cm² or less and the kind of the pressure-sensitive adhesive which forms the pressure-sensitive adhesive layer is not particularly limited. Examples of the pressure-sensitive adhesive for forming the pressure-sensitive adhesive layer of the invention include known pressure-sensitive adhesives such as acrylic pressure-sensitive adhesives, rubber pressure-sensitive adhesives, vinyl alkyl ether pressure-sensitive adhesives, silicone pressure-sensitive adhesives, polyester pressure-sensitive adhesives, polyamide pressure-sensitive adhesives, urethane pressure-sensitive adhesives, fluorine pressure-sensitive adhesives, and epoxy pressure-sensitive adhesives. These pressure-sensitive adhesives can be used solely or in combination of two or more kinds thereof. In this regard, the pressure-sensitive adhesive may be a pressure-sensitive adhesive having any form. For example, emulsion type pressure-sensitive adhesives, solvent type (solution type) pressure-sensitive adhesives, active energy ray-curable pressure-sensitive adhesives, hot melt type pressure-sensitive adhesives, and the like can be used.

As the pressure-sensitive adhesive for forming the pressure-sensitive adhesive layer of the invention, an acrylic pressure-sensitive adhesive is preferable among the above pressure-sensitive adhesives. Namely, the pressure-sensitive adhesive layer of the invention is preferably an acrylic pressure-sensitive adhesive layer. The acrylic pressure-sensitive adhesive layer is a pressure-sensitive adhesive layer containing as a base polymer an acrylic polymer which is formed using an acrylic monomer as an essential monomer component. The acrylic polymer is preferably an acrylic polymer formed using a (meth)acrylic acid alkyl ester (alkyl (meth)acrylate) having a linear or branched alkyl group and/or a (meth)acrylic acid alkoxyalkyl ester (alkoxyalkyl (meth)acrylate) as essential monomer component(s) (further preferably, as main monomer component(s)). Furthermore, the acrylic polymer is particularly preferably an acrylic polymer formed using a (meth)acrylic acid alkyl ester having a linear or branched alkyl group and a (meth)acrylic acid alkoxyalkyl ester as essential monomer components (further preferably, as main monomer components). Namely, the pressure-sensitive adhesive layer of the invention is particularly preferably an acrylic pressure-sensitive adhesive layer formed using a (meth)acrylic acid alkyl ester having a linear or branched alkyl group and a (meth)acrylic acid alkoxyalkyl ester as essential monomer components (further preferably, as main monomer components).

In the case where an acrylic acid alkoxyalkyl ester is contained as an essential monomer component for forming the acrylic polymer as a base polymer in the pressure-sensitive adhesive layer of the invention, not only the stress relaxation property, but also the foaming/peeling resistance of the pressure-sensitive adhesive layer is improved, so that the case is preferred. It is considered that this is because, since an appropriate intertwisting of molecular chains occurs when the acrylic polymer is transformed into a high-molecular-weight one by crosslinking owing to the effect of the alkoxyl group (alkoxy group) of the acrylic acid alkoxyalkyl ester, a high pressure-sensitive adhesive force can be exhibited even under high temperature and also the storage modulus of the pressure-sensitive adhesive layer does not decrease even under high temperature. Namely, even in the case where the gel fraction and storage modulus (23° C.) of the pressure-sensitive adhesive layer are made relatively low, the pressure-sensitive adhesive force and storage modulus under high temperature do not excessively decrease and both of the stress relaxation property and the foaming/peeling resistance can be achieved.

Moreover, the monomer component(s) for forming the acrylic polymer as a base polymer in the pressure-sensitive adhesive layer of the invention may further contain a polar group-containing monomer, a polyfunctional monomer, and other copolymerizable monomers as copolymerizable monomer components.

In this regard, the above-mentioned “(meth)acryl” indicates “acryl” and/or “methacryl” and the same shall apply hereinafter. Moreover, although not particularly limited, the content of the acrylic polymer as a base polymer in the pressure-sensitive adhesive layer of the invention is preferably 60% by weight or more (e.g., 60 to 100% by weight), more preferably 80 to 100% by weight.

As the essential monomer component(s) (further preferably main monomer component(s)) for forming the above-mentioned acrylic polymer, a (meth)acrylic acid alkyl ester having a linear or branched alkyl group (hereinafter simply referred to as a “(meth)acrylic acid alkyl ester” in some cases) can be suitably used. As the (meth)acrylic acid alkyl ester, there may be, for example, mentioned (meth)acrylic acid alkyl esters having an alkyl group having 1 to 20 carbon atoms, such as methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridodecyl (meth)acrylate, tetradecyl (meth)acrylate, pentadecyl (meth)acrylate, hexadecyl (meth)acrylate, heptadecyl (meth)acrylate, octadecyl (meth)acrylate, nanodecyl (meth)acrylate, and eicosyl (meth)acrylate. The above (meth)acrylic acid alkyl esters can be used solely or in combination of two or more kinds thereof. Of these, (meth)acrylic acid alkyl esters having an alkyl group having 2 to 14 carbon atoms are preferred and more preferred are (meth)acrylic acid alkyl esters having an alkyl group having 2 to 10 carbon atoms. In particular, 2-ethylhexyl acrylate (2EHA) is preferred.

Moreover, as the essential monomer component(s) (further preferably main monomer component(s)) for forming the above-mentioned acrylic polymer, (meth)acrylic acid alkoxyalkyl esters (alkoxyalkyl (meth)acrylates) can be suitably used. Particularly preferred are acrylic acid alkoxyalkyl esters (alkoxyalkyl acrylates). The (meth)acrylic acid alkoxyalkyl esters are not particularly limited and there may be, for example, mentioned 2-methoxyethyl (meth)acrylate, 2-ethoxyethyl (meth)acrylate, methoxytriethylene glycol (meth)acrylate, 3-methoxypropyl (meth)acrylate, 3-ethoxypropyl (meth)acrylate, 4-methoxybutyl (meth)acrylate, and 4-ethoxybutyl (meth)acrylate. The (meth)acrylic acid alkoxyalkyl esters can be used solely or in combination of two or more kinds thereof. Of these, 2-methylethyl acrylate (2MEA) is preferred.

Incidentally, from the viewpoint of the adhesiveness of the pressure-sensitive adhesive layer, the content of the essential monomer component(s) [(meth)acrylic acid alkyl ester and/or (meth)acrylic acid alkoxyalkyl ester] for forming the above-mentioned acrylic polymer is preferably 5% by weight or more (e.g., 5 to 100% by weight), more preferably 5 to 95% by weight based on the total amount (100% by weight) of the monomer component(s) for forming the acrylic polymer. In this regard, in the case where both of the (meth)acrylic acid alkyl ester and the (meth)acrylic acid alkoxyalkyl ester are used as the monomer components, it is sufficient that the total amount (total content) of the (meth)acrylic acid alkyl ester and the (meth)acrylic acid alkoxyalkyl ester satisfies the above range.

Of the above-mentioned monomers, as the essential monomer component(s) for forming the acrylic polymer, it is preferred to use both of the (meth)acrylic acid alkyl ester and the (meth)acrylic acid alkoxyalkyl ester. In that case, the content of the (meth)acrylic acid alkyl ester is preferably 5 to 95% by weight, more preferably 10 to 90% by weight, further preferably 65 to 80% by weight, and most preferably 65 to 75% by weight based on the total amount (100% by weight) of the monomer component(s) for forming the acrylic polymer. When the content thereof exceeds 95% by weight, the adhesiveness decreases in some cases. When the content thereof is less than 5% by weight, the modulus of the pressure-sensitive adhesive layer becomes too high in some cases. Moreover, the content of the (meth)acrylic acid alkoxyalkyl ester is preferably 10 to 45% by weight, more preferably 10 to 40% by weight, further preferably 20 to 35% by weight, and most preferably 20 to 34.5% by weight based on the total amount (100% by weight) of the monomer component(s) for forming the acrylic polymer. When the content thereof exceeds 45% by weight, the modulus of the pressure-sensitive adhesive layer becomes too high in some cases. When the content thereof is less than 10% by weight, the adhesiveness decreases in some cases.

As the above-mentioned polar group-containing monomer, there may be, for example, mentioned carboxyl group-containing monomers such as (meth)acrylic acid, itaconic acid, maleic acid, fumaric acid, crotonic acid, and isocrotonic acid or anhydrides thereof (maleic anhydride, etc.); hydroxyl group-containing monomers including hydroxyalkyl (meth)acrylates such as 2-hydroxyethyl (meth)acrylate, 3-hydroxypropyl (meth)acrylate, 4-hydroxybutyl (meth)acrylate, and 6-hydroxyhexyl (meth)acrylate, vinyl alcohol, and allyl alcohol; amido group-containing monomers such as (meth)acrylamide, N,N-dimethyl(meth)acrylamide, N-methylol(meth)acrylamide, N-methoxymethyl(meth)acrylamide, N-butoxymethyl(meth)acrylamide, and N-hydroxyethylacrylamide; amino group-containing monomers such as aminoethyl (meth)acrylate, dimethylaminoethyl (meth)acrylate, and t-butylaminoethyl (meth)acrylate; glycidyl group-containing monomers such as glycidyl (meth)acrylate and methylglycidyl (meth)acrylate; cyano group-containing monomers such as acrylonitrile and methacrylonitrile; heterocyclic ring-containing vinyl monomers such as N-vinyl-2-pyrrolidone and (meth)acryloylmorpholine and also N-vinylpyridine, N-vinylpiperidone, N-vinylpyrimidine, N-vinylpiperazine, N-vinylpyrrole, N-vinylimidazole, and N-vinyloxazole; sulfonic acid group-containing monomers such as sodium vinylsulfonate; phosphoric acid group-containing monomers such as 2-hydroxyethylacryloyl phosphate; imido group-containing monomers such as cyclohexylmaleimide and isopropylmaleimide; and isocyanate group-containing monomers such as 2-methacryloyloxyethyl isocyanate. The polar group-containing monomers can be used solely or in combination of two or more kinds thereof. As the polar group-containing monomers, of the above monomers, carboxyl group-containing monomers or acid anhydrides thereof, hydroxyl group-containing monomers, amino group-containing monomers, amido group-containing monomers, heterocyclic ring-containing vinyl monomers are preferred. Particularly preferred are acrylic acid (AA), 4-hydroxybutyl acrylate (4HBA), N-vinyl-2-pyrrolidone (NVP), and N-hydroxyethylacrylamide (HEAA).

The content of the polar group-containing monomer is preferably 15% by weight or less (e.g., 0.01 to 15% by weight), more preferably 1 to 15% by weight based on the total amount (100% by weight) of the monomer component(s) for forming the acrylic polymer. When the content thereof exceeds 15% by weight, for example, the cohesive force of the pressure-sensitive adhesive layer becomes too high and the storage modulus (23° C.) becomes too high, so that there is a concern that the stress relaxation property decreases. When the content thereof is too small such as less than 0.01% by weight, the adhesiveness decreases in some cases.

Of the above monomers, particularly, the content of the hydroxyl group-containing monomer is preferably 5% by weight or less (0 to 5% by weight), more preferably 0.01 to 5% by weight, further preferably 0.1 to 5% by weight, and most preferably 0.5 to 5% by weight based on the total amount (100% by weight) of the monomer component(s) for forming the acrylic polymer. When the content thereof exceeds 5% by weight, the cohesive force of the pressure-sensitive adhesive layer becomes too high and the storage modulus (23° C.) becomes too high, so that there is a concern that the stress relaxation property decreases. When the content thereof is less than 0.01% by weight, the cohesiveness of the pressure-sensitive adhesive layer decreases in some cases. Moreover, the content of the polar group-containing monomers other than the hydroxyl group-containing monomer (particularly, carboxyl group-containing monomers, amido group-containing monomers, amino group-containing monomers, heterocyclic ring-containing vinyl monomers) is preferably 15% by weight or less (0 to 15% by weight), more preferably 0.1 to 15% by weight, and further preferably 1 to 10% by weight based on the total amount (100% by weight) of the monomer component(s) for forming the acrylic polymer. When the content thereof exceeds 15% by weight, the cohesive force of the pressure-sensitive adhesive layer becomes too high and the storage modulus (23° C.) becomes too high, so that there is a concern that the stress relaxation property decreases. When the content thereof is less than 0.1% by weight, the adhesiveness decreases in some cases.

Examples of the above-mentioned polyfunctional monomer include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetraimethylolmethane tri(meth)acrylate, allyl (meth)acrylate, vinyl (meth)acrylate, divinylbenzene, epoxy acrylate, polyester acrylate, and urethane acrylate. The polyfunctional monomers can be used solely or in combination of two or more kinds thereof. As the polyfunctional monomer, of the above monomers, trimethylolpropane triacrylate (TMPTA) is preferred.

The content of the polyfunctional monomer is 0.5% by weight or less (e.g., 0 to 0.5% by weight), preferably 0 to 0.1% by weight based on the total amount (100% by weight) of the monomer component(s) for forming the acrylic polymer. When the content thereof exceeds 0.5% by weight, for example, the cohesive force of the pressure-sensitive adhesive layer becomes too high, so that there is a concern that the stress relaxation property decreases. Incidentally, in the case where a crosslinking agent is used, the polyfunctional monomer may not be used but in the case where the crosslinking agent is not used, the content of the polyfunctional monomer is preferably 0.001 to 0.5% by weight, more preferably 0.002 to 0.1% by weight.

Moreover, examples of the copolymerizable monomers (other copolymerizable monomers) other than the above-mentioned polar group-containing monomers and polyfunctional monomers include (meth)acrylic acid esters other than the above-mentioned (meth)acrylic acid alkyl esters, (meth)acrylic acid alkoxyalkyl esters, polar group-containing monomers, and polyfunctional monomers, e.g., (meth)acrylic acid ester having an alicyclic hydrocarbon group, such as cyclopentyl (meth)acrylate, cyclohexyl (meth)acrylate, and isobornyl (meth)acrylate and (meth)acrylic acid esters having an aromatic hydrocarbon group, such as phenyl (meth)acrylate; vinyl esters such as vinyl acetate and vinyl propionate; aromatic vinyl compounds such as styrene and vinyl toluene; olefins or dienes such as ethylene, butadiene, isoprene, and isobutylene; vinyl ethers such as vinyl alkyl ethers; and vinyl chloride.

The above-mentioned acrylic polymer can be prepared by polymerizing the above-mentioned monomer component(s) using known or common polymerization methods. Examples of methods for polymerization to the acrylic polymer include a solution polymerization method, an emulsion polymerization method, a bulk polymerization method, and a polymerization method with active energy ray irradiation (active energy ray polymerization method). The solution polymerization method and active energy ray polymerization method are preferred from the viewpoints of transparency, water resistance, costs, and the like, and particularly, in the case of forming a relatively thick pressure-sensitive adhesive layer, the active energy ray polymerization method (sometimes referred to as photopolymerization) is preferred. In particular, an ultraviolet polymerization method by ultraviolet ray irradiation is preferred.

As the active energy ray with which irradiation is conducted at the above-mentioned active energy ray polymerization (photopolymerization), there may be, for example, mentioned ionizing radiations such as α-ray, β-ray, γ-ray, neutron radiation, electron beam, and ultraviolet ray and particularly, ultraviolet ray is suitable. Moreover, the irradiation energy, irradiation time, irradiation method, and the like of the active energy ray are not particularly limited and it is sufficient that they are such that a photopolymerization initiator can be activated to induce a reaction of the polymer component(s).

In the solution polymerization, various common solvents can be used. As such solvents, there may be mentioned organic solvents including esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; ketones such as methyl ethyl ketone and methyl isobutyl ketone. The solvents can be used solely or in combination of two or more kinds thereof.

In the preparation of the above-mentioned acrylic polymer, a polymerization initiator such as a thermal polymerization initiator or a photopolymerization initiator (photo initiator) can be used depending on the kind of the polymerization reaction. The polymerization initiators can be used solely or in combination of two or more kinds thereof.

The photopolymerization initiator is not particularly limited and, for example, benzoin ether photopolymerization initiators, acetophenone photopolymerization initiators, α-ketol photopolymerization initiators, aromatic sulfonyl chloride photopolymerization initiators, photoactive oxime photopolymerization initiators, benzoin photopolymerization initiators, benzil photopolymerization initiators, benzophenone photopolymerization initiators, ketal photopolymerization initiators, and thioxanthone photopolymerization initiators can be used. The amount of the photopolymerization initiator is not particularly limited and is, for example, preferably 0.01 to 0.2 part by weight, more preferably 0.05 to 0.15 part by weight based on the total amount (100 parts by weight) of the monomer component(s) for forming the acrylic polymer.

Examples of the benzoin ether photopolymerization initiators include benzoin methyl ether, benzoin ethyl ether, benzoin propyl ether, benzoin isopropyl ether, benzoin isobutyl ether, 2,2-dimethoxy-1,2-diphenylethan-1-one, and anisole methyl ether. Examples of the acetophenone photopolymerization initiators include 2,2-diethoxyacetophenone, 2,2-dimethoxy-2-phenylacetophenone, 1-hydroxycyclohexyl phenyl ketone, 4-phenoxydichloroacetophenone, and 4-(t-butyl)dichloroacetophenone. Examples of the α-ketol photopolymerization initiators include 2-methyl-2-hydroxypropiophenone and 1-[4-(2-hydroxyethyl)phenyl]-2-methylpropan-1-one. Examples of the aromatic sulfonyl chloride photopolymerization initiators include 2-naphthalenesulfonyl chloride. Examples of the photoactive oxime photopolymerization initiators include 1-phenyl-1,1-propanedione-2-(o-ethoxycarbonyl)-oxime. Examples of the benzoin photopolymerization initiators include benzoin. Examples of the benzil photopolymerization initiators include benzil. Examples of the benzophenone photopolymerization initiators include benzophenone, benzoylbenzoic acid, 3,3′-dimethyl-4-methoxybenzophenone, polyvinylbenzophenone, and α-hydroxycyclohexyl phenyl ketone. Examples of the ketal photopolymerization initiators include benzil dimethyl ketal. Examples of the thioxanthone photopolymerization initiators include thioxanthone, 2-chlorothioxanthone, 2-methylthioxanthone, 2,4-dimethylthioxanthone, isopropylthioxanthone, 2,4-diisopropylthioxanthone, and dodecylthioxanthone.

Examples of the thermal polymerization initiators include azo polymerization initiators such as 2,2′-azobisisobutyronitrile, 2,2′-azobis-2-methylbutyronitrile, dimethyl 2,2′-azobis(2-methylpropionate), 4,4′-azobis-4-cyanovaleric acid, azobisisovaleronitrile, 2,2′-azobis(2-amidinopropane) dihydrochloride, 2,2′-azobis[2-(5-methyl-2-imidazolin-2-yl)propane] dihydrochloride, 2,2′-azobis(2-methylpropionamidine) disulfate, and 2,2′-azobis(N,N′-dimethyleneisobutylamidine) dihydrochloride; peroxide polymerization initiators such as dibenzoyl peroxide and tert-butyl permaleate; and redox polymerization initiators. The amount of the thermal polymerization initiator is not particularly limited and may be in the range hitherto capable of being utilizable as a thermal polymerization initiator.

In the pressure-sensitive adhesive layer of the invention, according to needs, known additives such as crosslinking agents, crosslinking accelerators, tackifiers (e.g., rosin derivative resins, polyterpene resins, petroleum resins, oil-soluble phenol resins, etc.), aging inhibitors, fillers, colorants (pigments, dyes, etc.), ultraviolet absorbers, antioxidants, chain transfer agents, plasticizers, softeners, surfactants, and antistatic agents can be used in the range where the characteristics of the invention are not impaired. Moreover, at the formation of the pressure-sensitive adhesive layer, various common solvents can be also used. The kind of the solvent is not particularly limited and those exemplified as the solvent to be used in the above-mentioned solution polymerization can be used.

The crosslinking agent can control the gel fraction of the pressure-sensitive adhesive layer by crosslinking the base polymer of the pressure-sensitive adhesive layer (e.g., the above-mentioned acrylic polymer, etc.). As the crosslinking agent, there may be mentioned isocyanate crosslinking agents, epoxy crosslinking agents, melamine crosslinking agents, and peroxide crosslinking agents, and also urea crosslinking agents, metal alkoxide crosslinking agents, metal chelate crosslinking agents, metal salt crosslinking agents, carbodiimide crosslinking agents, oxazoline crosslinking agents, aziridine crosslinking agents, and amine crosslinking agents. The isocyanate crosslinking agents and epoxy crosslinking agents can be suitably used. The crosslinking agents can be used solely or in combination of two or more kinds thereof.

Examples of the isocyanate crosslinking agents include lower aliphatic polyisocyanates such as 1,2-ethylene diisocyanate, 1,4-butylene diisocyanate, and 1,6-hexamethylene diisocyanate; alicyclic polyisocyanates such as cyclopentylene diisocyanate, cyclohexylene diisocyanate, isophorone diisocyanate, hydrogenated tolylene diisocyanate, and hydrogenated xylylene diisocyanate; and aromatic polyisocyanates such as 2,4-tolylene diisocyanate, 2,6-tolylene diisocyanate, 4,4′-diphenylmethane diisocyanate, and xylylene diisocyanate. In addition, a trimethylolpropane/tolylene diisocyanate adduct [product name “COLONATE L” manufactured by Nippon Polyurethane Industry Co., Ltd.], a trimethylolpropane/hexamethylene diisocyanate adduct [product name “COLONATE HL” manufactured by Nippon Polyurethane Industry Co., Ltd.], and the like are also used.

Examples of the epoxy crosslinking agent include N,N,N′,N′-tetraglycidyl-m-xylenediamine, diglycidylaniline, 1,3-bis(N,N-glycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropnane polyglycidyl ether, adipic acid diglycidyl ester, o-phthalic acid diglycidyl ester, triglycidyl-tris(2-hydroxyethyl) isocyanurate, resorcin diglycidyl ether, and bisphenol-S-diglycidyl ether, and also epoxy-based resins having two or more epoxy groups in the molecule. As a commercially available product, there may be, for example, mentioned a product name “TETRAD C” manufactured by Mitsubishi Gas Chemical Co., Inc.

The amount of the crosslinking agent to be used is not particularly limited. For example, in the case of the acrylic pressure-sensitive adhesive layer, the amount is preferably 0 to 1 part by weight, more preferably 0 to 0.8 part by weight based on the total amount (100 parts by weight) of the monomer component(s) for forming the acrylic polymer.

As a method for forming the pressure-sensitive adhesive layer of the invention, it is possible to use a known conventional method for forming a pressure-sensitive adhesive layer and the method also varies depending on the polymerization method for the base polymer without particular limitation. For example, the following methods (1) to (3) may be mentioned. (1) A composition containing a mixture (monomer mixture) of the monomer components for forming a base polymer (e.g., acrylic polymer) or a partially polymerized product thereof and optional additives such as a photopolymerization initiator and a crosslinking agent is applied (coated) onto a substrate or a release liner and the composition is irradiated with an active energy ray to form a pressure-sensitive adhesive layer. (2) A composition (solution) containing a base polymer, a solvent, and optional additives such as a crosslinking agent is applied (coated) onto a substrate or a release liner and the composition is dried and/or cured to form a pressure-sensitive adhesive layer. (3) The pressure-sensitive adhesive layer formed in the above (1) is further dried. Of the above methods, in the case of forming a relatively thick pressure-sensitive adhesive layer (e.g., a pressure-sensitive adhesive layer having a thickness of 70 μm or more), the method for forming the pressure-sensitive adhesive layer as mentioned in the above (1) or (3) is preferred. In this regard, the above-mentioned “monomer mixture” means a mixture composed only of the monomer components for forming the base polymer. Moreover, the above-mentioned “partially polymerized product” means a composition where one or two or more components of the constitutional components of the monomer mixture are partially polymerized.

Incidentally, for the application (coating) in the above-mentioned method for forming the pressure-sensitive adhesive layer, it is possible to use a coater in common use, for example, a gravure roll coater, a reverse-roll coater, a kiss-roll coater, a dip-roll coater, a bar coater, a knife coater, a spray coater, a comma coater, or a direct coater.

As one example of preferred specific constitutions of the pressure-sensitive adhesive layer of the invention (one example of the acrylic pressure-sensitive adhesive layer), there may be mentioned a pressure-sensitive adhesive layer (acrylic pressure-sensitive adhesive layer) formed by irradiating with an active energy ray a composition containing a mixture (monomer mixture) of the monomer components containing a (meth)acrylic acid alkyl ester and an acrylic acid alkoxyalkyl ester as essential components or a partially polymerized product thereof to effect active energy ray polymerization. The composition for forming the acrylic pressure-sensitive adhesive layer preferably contains a photopolymerization initiator. Moreover, according to needs, the composition may contain a crosslinking agent and other additives. Furthermore, the content of the acrylic acid alkoxyalkyl ester in the monomer mixture is preferably 10 to 45% by weight.

In the case where the pressure-sensitive adhesive layer of the invention is an acrylic pressure-sensitive adhesive layer, the gel fraction, storage modulus (23° C.), loss modulus (23° C.), residual stress, and 300% tensile stress of the pressure-sensitive adhesive layer can be regulated by appropriately regulating the kind and amount of the monomers for forming the acrylic polymer, the kind and amount of the crosslinking agent, and the like within the above-mentioned ranges. Of these, the gel fraction can be, for example, regulated by the content of the polyfunctional monomer and the amount of the crosslinking agent to be used. The storage modulus (23° C.) can be, for example, regulated by the monomer composition. The loss modulus (23° C.) can be, for example, regulated by the monomer composition. The residual stress and 300% tensile stress can be, for example, regulated by the monomer composition and the amount of the crosslinking agent to be used.

In view of controlling the gel fraction, storage modulus (23° C.), and residual stress to specific ranges, as a particularly preferred constitution as the pressure-sensitive adhesive layer of the invention, there may be, for example, mentioned the following pressure-sensitive adhesive layers (acrylic pressure-sensitive adhesive layers) (1) and (2) but the constitution is not limited thereto.

(1) An acrylic pressure-sensitive adhesive layer formed by irradiating with an active energy ray a composition containing a monomer mixture containing 65 to 75% by weight of 2EHA, 20 to 35% by weight (preferably 20 to 34.5% by weight) of 2MEA, 0 to 5% by weight of acrylic acid, 0.1 to 3% by weight of 4HBA, and 0.002 to 0.02% by weight of TMPTA or a partially polymerized product thereof.
(2) An acrylic pressure-sensitive adhesive layer formed by irradiating with an active energy ray a composition containing a monomer mixture containing 65 to 75% by weight of 2EHA, 20 to 35% by weight (preferably 20 to 34.5% by weight) of 2MEA, 0 to 5% by weight of acrylic acid, and 0.1 to 3% by weight of 4HBA or a partially polymerized product thereof and 0.001 to 0.02% by weight (preferably 0.007 to 0.02% by weight) of an epoxy crosslinking agent or 0.01 to 0.8% by weight of an isocyanate crosslinking agent based on 100 parts by weight of the monomer mixture or the partially polymerized product thereof.

### (Substrate)

In the case where the double-sided pressure-sensitive adhesive sheet of the invention is a substrate-attached double-sided pressure-sensitive adhesive sheet, the substrate is not particularly limited but examples thereof include various optical films such as plastic films, antireflection (AR) films, polarizing plates, and retardation plates. Examples of materials of the plastic films and the like include plastic materials such as polyester resins, e.g., polyethylene terephthalate (PET); acrylic resins, e.g., polymethyl methacrylate (PMMA); polycarbonates; triacetylcellulose; polysulfones; polyarylates; and cycloolefin polymers, e.g., a product name “ARTON” (cycloolefin polymer; manufactured by JSR Co., Ltd.) and a product name “ZEONOR” (cycloolefin polymer; manufactured by Nippon Zeon Co., Ltd.). Such plastic materials can be used solely or in combination of two or more kinds thereof. Moreover, the above-mentioned “substrate” is a part which is adhered to the adherend together with the pressure-sensitive adhesive layer at the time of using (adhering) the double-sided pressure-sensitive adhesive sheet to adherends (optical members etc.). The release liner (separator) to be peeled off at the time of using (adhering) the double-sided pressure-sensitive adhesive sheet is not included in the “substrate”.

Among the above, the substrate is preferably a transparent substrate. The “transparent substrate” is, for example, preferably a substrate having a total light transmittance as measured in the visible light wavelength region (in accordance with JIS K 7361) of 85% or higher, and more preferably a substrate having a total light transmittance of 90% or higher. Moreover, as the above transparent substrate, there may be mentioned non-oriented films such as PET films, a product name “ARTON”, and a product name “ZEONOR”.

The thickness of the above-mentioned substrate is not particularly limited and, for example, is preferably 25 to 50 μm. In this regard, the substrate may have either a single-layer constitution or a multilayer constitution. The surfaces of the substrate may have undergone an appropriate surface treatment which is known or in common use, e.g., a physical treatment such as corona discharge treatment or plasma treatment or a chemical treatment such as undercoating.

### (Other Pressure-Sensitive Adhesive Layer)

In the case where the double-sided pressure-sensitive adhesive sheet of the invention has another pressure-sensitive adhesive layer (may be referred to as “other pressure-sensitive adhesive layer”), such other pressure-sensitive adhesive layer is not particularly limited and examples thereof include known and commonly used pressure-sensitive adhesive layers formed from known pressure-sensitive adhesives such as urethane pressure-sensitive adhesives, acrylic pressure-sensitive adhesives, rubber pressure-sensitive adhesives, silicone pressure-sensitive adhesives, polyester pressure-sensitive adhesives, polyamide pressure-sensitive adhesives, epoxy pressure-sensitive adhesives, vinyl alkyl ether pressure-sensitive adhesives, and fluorine pressure-sensitive adhesives. The pressure-sensitive adhesives can be used solely or in combination of two or more kinds thereof.

### (Release Liner)

The surface of the pressure-sensitive adhesive layer (pressure-sensitive adhesive surface) of the double-sided pressure-sensitive adhesive sheet of the invention may be protected with a release liner (separator) before the time of use. In this regard, the respective pressure-sensitive adhesive surfaces may be protected with two sheets of release liners, respectively, or the surfaces may be protected in the form wound as a roll with one sheet of a release liner whose double surfaces are releasable surfaces. The release liner is used as a protective material of the pressure-sensitive adhesive layer and is peeled off at the time of adhesion to adherends. Moreover, when the double-sided pressure-sensitive adhesive sheet of the invention is a substrate-less pressure-sensitive adhesive sheet, the release liner also plays a role of a support of the pressure-sensitive adhesive layer. The release liner may be not necessarily provided. As the release liner, a release paper in common use and the like can be used and the liner is not particularly limited. For example, there can be used a substrate having a releasant-treated layer, a substrate having low adhesiveness, which is composed of a fluorine polymer, a substrate having low adhesiveness, which is composed of a non-polar polymer, or the like. As the substrate having a releasant-treated layer, there may be, for example, mentioned a plastic film or paper whose surface is treated with a releasant such as a silicone type, long-chain alkyl type, fluorine type one, or molybdenum sulfide. As the fluorine polymer in the substrate having low adhesiveness, which is composed of the fluorine polymer, there may be, for example, mentioned polytetrafluoroethylene, polychlorotrifluoroethylene, polyvinyl fluoride, polyvinylidene fluoride, a tetrafluoroethylene-hexafluoropropylene copolymer, and a chlorofluoroethylene-vinylidene fluoride copolymer. As the non-polar polymer in the substrate having low adhesiveness, which is composed of a non-polar polymer, there may be, for example, mentioned olefin resins such as polyethylene and polypropylene and the like. Incidentally, the release liner can be formed by known and conventional methods. Moreover, the thickness of the release liner is not particularly limited.

The applications of the double-sided pressure-sensitive adhesive sheet of the invention are not particularly limited and the applications of adhering optical member(s) (double-sided pressure-sensitive adhesive sheet for optical member adhesion) are preferably exemplified. The optical member means a member having an optical property (e.g., a polarizing property, a photorefractive property, a light scattering property, a light reflective property, a light transmitting property, a light absorbing property, a light diffracting property, an optical rotatory property, a visible property, or the like). The optical member is not particularly limited so long as it is a member having an optical property. For example, there may be mentioned members constituting devices such as display devices (image display devices) and input devices or members for use in these devices. Examples thereof include polarizing plates, wavelength plates, retardation plates, optical compensation films, luminance enhancing films, optical wave guides, reflection films, antireflection films, transparent conductive films (ITO film etc.), design films, decorative films, surface protective films, prisms, lenses, color filters, transparent substrates, and also members obtained by lamination thereof. In this regard, the above-mentioned “plate” and “film” also include plate-like, film-like, sheet-like, or the like form. For example, the “polarizing plate” also includes a “polarizing film” and a “polarizing sheet”.

Examples of the above-mentioned display devices include liquid crystal display devices, organic EL (electroluminescence) display devices, PDP (plasma display panel), and electronic papers. Moreover, examples of the above-mentioned input devices include touch panels.

Among the above, the double-sided pressure-sensitive adhesive sheet of the invention is preferably used in the applications for adhering a member constituting a liquid crystal display device or a member for use in a liquid crystal display device (for adhering optical member for liquid crystal display device). More specifically, the sheet is preferably used for adhering a polarizing plate to a lens or the like application.

The above-mentioned optical member is not particularly limited but examples thereof include members composed of an acrylic resin, polycarbonate, polyethylene terephthalate, glass, a metal thin film, or the like (e.g., sheet-like, film-like, or plate-like members). Incidentally, the “optical member” in the invention also includes a member playing a role of decoration or protection while a visible property of the display device or input device as an adherend is maintained (a design film, a decorative film, a surface protective film, etc) as mentioned above.

In this regard, by adhering or laminating the double-sided pressure-sensitive adhesive sheet of the invention to the surface (at least one surface) of an optical member, a pressure-sensitive adhesive type optical member having a pressure-sensitive adhesive layer (preferably the pressure-sensitive adhesive layer of the invention) on at least one surface of the optical member can be obtained.

### EXAMPLES

The present invention will be explained below in more detail with reference to Examples, but the invention is not limited to these Examples.

Incidentally, Table 1 shows the monomer-blending composition of monomers [monomer species and monomer ratio (weight ratio)] in the preparation of a prepolymer composition and the blending composition of a composition for acrylic pressure-sensitive adhesive layer formation used in each of Examples and Comparative Examples.

### Example 1

To a mixture obtained by mixing 69 parts by weight of 2-ethylhexyl acrylate (2EHA), 30 parts by weight of 2-methoxyethyl acrylate (2MEA), 1 part by weight of 4-hydroxybutyl acrylate (4HBA), and 1 part by weight of acrylic acid (AA) were blended 0.05 part by weight of a product name “IRGACURE 184” manufactured by Ciba Specialty Chemicals and 0.05 part by weight of a product name “IRGACURE 651” manufactured by Ciba Specialty Chemicals. Thereafter, the contents were irradiated with ultraviolet ray until viscosity (BH viscosimeter, No. 5 rotor, 10 rpm, measuring temperature 30° C.) reached about 20 Pa·s to prepare a prepolymer composition in which a part of the above-mentioned monomer components were polymerized.

To 100 parts by weight of the prepolymer composition was added 0.01 part by weight of trimethylolpropane triacrylate (TMPTA), thereby a composition for acrylic pressure-sensitive adhesive layer formation being prepared.

The composition for acrylic pressure-sensitive adhesive layer formation was applied on a polyethylene terephthalate (PET) separator (“MRF75” manufactured by Mitsubishi Plastics, Inc.) so that the final thickness (thickness of the pressure-sensitive adhesive layer) became 150 thereby a coated layer being formed.

Then, a PET separator (“MRF38” manufactured by Mitsubishi Plastics, Inc.) was provided on the coated layer, thereby the coated layer being covered to block oxygen.

Thereafter, ultraviolet ray having an illuminance of 5 mW/cm² was applied from the upper surface (MRF38 side) of the sheet (a laminate of MRF75/coated layer/MRF38) for 300 seconds by means of a black light (manufactured by Toshiba Corporation). Furthermore, the sheet was subjected to a heat treatment for 2 minutes in a dryer at 120° C. to evaporate remaining monomers, thereby a pressure-sensitive adhesive layer (acrylic pressure-sensitive adhesive layer) being formed. Then, the sheet was subjected to heat aging at 50° C. for 1 week to obtain a double-sided pressure-sensitive adhesive sheet (substrate-less double-sided pressure-sensitive adhesive sheet) having a thickness of 150 μm.

### Examples 2 and 3, Comparative Example 1

Compositions for acrylic pressure-sensitive adhesive layer formation were prepared in the same manner as in Example 1 except that the amount of TMPTA added was changed in Example 2 and TMPTA was not added and an epoxy crosslinking agent (“TETRAD C” manufactured by Mitsubishi Gas Chemical Co., Inc.) was added in Example 3 and Comparative Example 1, as shown in Table 1.

Moreover, using the compositions for acrylic pressure-sensitive adhesive layer formation, double-sided pressure-sensitive adhesive sheets (substrate-less double-sided pressure-sensitive adhesive sheets) were obtained in the same manner as in Example 1.

### Examples 4 to 7

Prepolymer compositions were prepared in the same manner as in Example 1 except that the ratio of acrylic acid (AA) was changed as shown in Table 1.

TMPTA or Tetrad C was added to the prepolymer compositions obtained in the above as shown in Table 1 to prepare compositions for acrylic pressure-sensitive adhesive layer formation.

Moreover, using the compositions for acrylic pressure-sensitive adhesive layer formation, double-sided pressure-sensitive adhesive sheets (substrate-less double-sided pressure-sensitive adhesive sheets) were obtained in the same manner as in Example 1.

### Example 8

A prepolymer composition was prepared in the same manner as in Example 1 except that a mixture obtained by mixing 68 parts by weight of 2-ethylhexyl acrylate (2EHA), 24 parts by weight of 2-methoxyethyl acrylate (2MEA), 6 parts by weight of N-vinyl-2-pyrrolidone (NVP), and 2 parts by weight of N-hydroxyethylacrylamide (HEAA) was used.

An isocyanate crosslinking agent (“CORONATE HL” manufactured by Nippon Polyurethane Industry Co., Ltd.) was added to the prepolymer composition obtained in the above as shown in Table 1, thereby a composition for acrylic pressure-sensitive adhesive layer formation being prepared.

Moreover, using the composition for acrylic pressure-sensitive adhesive layer formation, a double-sided pressure-sensitive adhesive sheet (substrate-less double-sided pressure-sensitive adhesive sheet) was obtained in the same manner as in Example 1.

Incidentally, in Table 1, the amount (blending amount) of the isocyanate crosslinking agent (CORONATE L, CORONATE HL) added is shown as an amount (part(s) by weight) in terms of solid content.

### Example 9 and 10

Prepolymer compositions were prepared in the same manner as in Example 1 except that acrylic acid (AA) was not used as shown in Table 1.

An isocyanate crosslinking agent (“CORONATE L” manufactured by Nippon Polyurethane Industry Co., Ltd.) was added to the prepolymer compositions obtained in the above as shown in Table 1, thereby compositions for acrylic pressure-sensitive adhesive layer formation being prepared.

Moreover, using the compositions for acrylic pressure-sensitive adhesive layer formation, double-sided pressure-sensitive adhesive sheets (substrate-less double-sided pressure-sensitive adhesive sheets) were obtained in the same manner as in Example 1.

### Example 11

A prepolymer composition and a composition for acrylic pressure-sensitive adhesive layer formation were prepared in the same manner as in Example 8 except that the weight ratio of 2EHA, 2MEA, NVP, and HEAA was changed as shown in Table 1 and then a double-sided pressure-sensitive adhesive sheet (substrate-less double-sided pressure-sensitive adhesive sheet) was obtained.

### Comparative Examples 2 and 3

Prepolymer compositions and compositions for acrylic pressure-sensitive adhesive layer formation were prepared in the same manner as in Examples 9 and 10 except that the weight ratio of 2EHA, 2MEA, and 4HBA was changed as shown in Table 1 and then double-sided pressure-sensitive adhesive sheets (substrate-less double-sided pressure-sensitive adhesive sheets) were obtained.

### Comparative Example 4

A prepolymer composition was prepared in the same manner as in Example 1 except that a mixture obtained by mixing 70 parts by weight of 2-ethylhexyl acrylate (2EHA), 26 parts by weight of N-vinyl-2-pyrrolidone (NVP), and 4 parts by weight of N-hydroxyethylacrylamide (HEAA) was used.

An isocyanate crosslinking agent (“CORONATE L” manufactured by Nippon Polyurethane Industry Co., Ltd.) was added to the prepolymer composition obtained in the above as shown in Table 1, thereby a composition for acrylic pressure-sensitive adhesive layer formation being prepared.

Moreover, using the composition for acrylic pressure-sensitive adhesive layer formation, a double-sided pressure-sensitive adhesive sheet (substrate-less double-sided pressure-sensitive adhesive sheet) was obtained in the same manner as in Example 1.

### (Evaluation)

Each of the double-sided pressure-sensitive adhesive sheets (acrylic pressure-sensitive adhesive layers) obtained in Examples and Comparative Examples was subjected to the following evaluation. The evaluation results are shown in Table 1. Incidentally, the gel fraction was measured by the above-mentioned method.

### (1) Dynamic Viscoelasticity Measurement [Storage Modulus (23° C.), Loss Modulus (23° C.)]

With regard to each of the double-sided pressure-sensitive adhesive sheets obtained in Examples and Comparative Examples, a separator was peeled off from the double-sided pressure-sensitive adhesive sheet and only the acrylic pressure-sensitive adhesive layers were laminated to prepare a laminate of the acrylic pressure-sensitive adhesive layers having a thickness of about 1.5 mm, which was used as a measuring sample.

The measuring sample was measured under the condition of a frequency of 1 Hz in the temperature range of −70 to 200° C. at a temperature-elevating rate of 5° C./minute using “Advanced Rheometric Expansion System (ARES)” manufactured by Rheometric Scientific and storage modulus and loss modulus were calculated. The storage modulus and loss modulus at a temperature of 23° C. were shown as “storage modulus (23° C.)” and “loss modulus (23° C.)”, respectively.

### (2) Tensile Stress Relaxation Test [Residual Stress]

A sheet piece having a length of 40 mm and a width of 40 mm (40 mm×40 mm) was cut out from each of the double-sided pressure-sensitive adhesive sheets obtained in Examples and Comparative Examples.

Then, a separator was peeled off from the sheet piece and the cut-out sheet piece was rolled up into a cylindrical shape in a width direction, which was used as a measuring sample.

A tensile stress relaxation test was conducted using a tensile tester.

On the tensile tester, the measuring sample was set with adjusting the distance between chucks to 20 mm (initial distance between chucks was 20 mm).

The test piece was drawn by 60 mm (strain of 300%) at a drawing rate of 200 mm/minute at a measuring temperature of 23° C. (the distance between chucks after drawing was 80 mm).

At the position after drawn by 60 mm, the chuck position was fixed for 180 seconds (the strain of 300% was kept) and the stress (tensile stress) (N/cm²) after the passage of 180 seconds was measured, the stress being regarded as “residual stress”.

### (3) Tensile Stress Relaxation Test [300% Tensile Stress]

A sheet piece having a length of 40 mm and a width of 40 mm (40 mm×40 mm) was cut out from each of the double-sided pressure-sensitive adhesive sheets obtained in Examples and Comparative Examples.

Then, a separator was peeled off from the sheet piece and the cut-out sheet piece was rolled up into a cylindrical shape in a width direction, which was used as a measuring sample.

A tensile stress relaxation test was conducted using a tensile tester.

On the tensile tester, the measuring sample was set with adjusting the distance between chucks to 20 mm.

The test piece was drawn by 60 mm (strain of 300%) at a drawing rate of 200 mm/minute at a measuring temperature of 23° C. (the distance between chucks after drawing was 80 mm).

At the position after drawn by 60 mm, the chuck position was fixed for 180 seconds (the strain of 300% was kept) and a maximum value of the stress (tensile stress) (N/cm²) was measured, the value being regarded as “300% tensile stress” (usually, the stress immediately after completion of drawing becomes the maximum value).

### (4) 180° Peeling Pressure-Sensitive Adhesive Force (vs Acrylic Plate, vs Polarizing Plate)

A sheet piece having a width of 25 mm and a length of 150 mm (25 mm×150 mm) was cut out from each of the double-sided pressure-sensitive adhesive sheets obtained in Examples and Comparative Examples and then a separator was peeled off from the sheet piece. A PET film (“LUMIRROR S-10” manufactured by Toray Industries, Inc.) having a thickness of 25 μm was adhered (backed) onto one pressure-sensitive adhesive surface (a surface opposite to the measuring surface) to produce a strip sheet piece.

Then, a separator was peeled from the strip sheet piece and another side of the pressure-sensitive adhesive surface (measuring surface) was adhered to a test plate by reciprocating a 2 kg rubber roller (width: about 50 mm) once to produce a measuring sample.

After the measuring sample was allowed to stand in an atmosphere of 23° C. and 50% RH for 0.5 hour, 180° peeling test was conducted in accordance with JIS Z 0237 using a tensile tester to measure 180° peeling strength (180° peeling pressure-sensitive adhesive force) (N/25 mm) against the test plate. The measurement was conducted under an atmosphere of 23° C. and 50% RH under the conditions of a peeling angle of 180° and a drawing rate of 300 mm/minute. The number of the test was three times (n value).

The 180° peeling strength in the case of using an acrylic plate (“ACRYLITE” manufactured by Mitsubishi Rayon Co., Ltd., thickness: 2 mm) as the test plate was regarded as “180° peeling pressure-sensitive adhesive force (vs acrylic plate)”.

Also, the 180° peeling strength in the case of using a polarizing plate (product name “TEG1465DUHC” manufactured by Nitto Denko Corporation, hard-coated surface) as the test plate was regarded as “180° peeling pressure-sensitive adhesive force (vs polarizing plate)”.

### (5) Foaming/Peeling Resistance

A glass plate (product name “S200423” manufactured by Matsunami Glass Ind. Ltd., thickness: 1.3 mm (average)) and a polymethyl methacrylate plate (“ACRYLITE MR-200” manufactured by Mitsubishi Rayon Co., Ltd., thickness: 1.5 mm) were cut into pieces of 50 mm×65 mm (length: 50 mm, width: 65 mm), respectively. Also, a polarizing plate (product name “TEG1465DUHC” manufactured by Nitto Denko Corporation) and each of the double-sided pressure-sensitive adhesive sheets obtained in Examples and Comparative Examples were cut into pieces of 70 mm×85 mm (length: 70 mm, width: 85 mm), respectively.

The glass plate and the PMMA plate were washed with a dust-proof cloth soaked with ethanol.

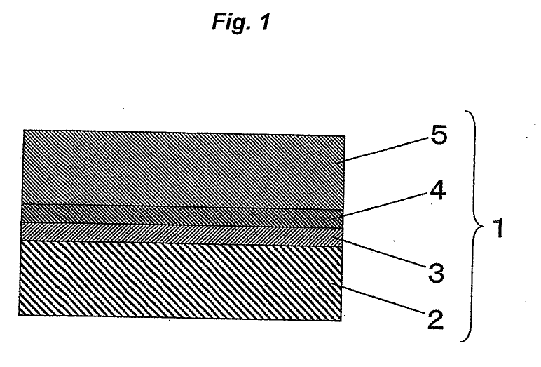

The glass plate 2 and the polarizing plate 3 were adhered by means of a hand roller. Then, using a laminator, the double-sided pressure-sensitive adhesive sheet 4 and the PMMA plate 5 were sequentially adhered to the polarizing plate 3 to prepare an adhered article having a structure of glass plate 2/polarizing plate 3/double-sided pressure-sensitive adhesive sheet 4/PMMA plate 5 adhered in this order, as shown in FIG. 1. Furthermore, the parts of the polarizing plate and the double-sided pressure-sensitive adhesive sheet run off the edges of the glass plate and the PMMA plate were cut off and the resulting adhered article was used as a test piece 1.

The test piece obtained in the above (adhered article of glass plate/polarizing plate/double-sided pressure-sensitive adhesive sheet/PMMA plate) was treated in an autoclave under the conditions of 50° C.×5 atm×15 minutes. Furthermore, after taken out of the autoclave, the test piece was stored in a dryer at 80° C. for 24 hours.

After the test piece was taken out of the dryer at 80° C., the state of the test piece after standing at room temperature for 30 minutes was observed by means of a microscope and was judged according to the following criteria.

Good (good foaming/peeling resistance): Bubbles (foaming) other than bubbles (foaming) caused by foreign particles are hardly present

Poor (poor foaming/peeling resistance): Bubbles (foaming) other than bubbles (foaming) caused by foreign particles are present

TABLE 1

| | | | | | | | PHYSICAL | |
|---|---|---|---|---|---|---|---|---|
| | | | | | | | PROPERTIES | |
| | | | | | | | | 180° |
| | Monomer-blending | Blending composition of composition | | | | | | peeling |
| | composition at | for acrylic pressure-sensitive | | | | | | pressure- |
| | preparation of pre- | adhesive layer formation | | | | | | sensitive |
| | polymer | Pre- | | | | | | adhesive |
| | composition | polymer | CORONATE | CORONATE | TETRAD | | | force (vs |
| | Monomer species | composition | L | HL | C | TMPTA | Gel | polarizing |
| | Monomer ratio | (parts by | (part by | (part by | (part by | (part by | fraction | plate) |
| | (weight ratio) | weight) | weight) | weight) | weight) | weight) | (%) | (N/25 mm) |
| Example 1 | 2EHA/2MEA/ | 100 | | | | 0.01 | 42 | 6.7 |
| | 4HBA/AA | | | | | | | |
| Example 2 | 69/30/1/1 | 100 | | | | 0.005 | 22 | 6.9 |
| Example 3 | | 100 | | | 0.010 | | 49 | 7.3 |
| Comparative | | 100 | | | 0.005 | | 7 | 7.4 |
| Example 1 | | | | | | | | |
| Example 4 | 2EHA/2MEA/ | 100 | | | | 0.01 | 46 | 4.8 |
| | 4HBA/AA | | | | | | | |
| Example 5 | 69/30/1/3 | 100 | | | | 0.005 | 28 | 5.1 |
| Example 6 | | 100 | | | 0.010 | | 47 | 4.9 |
| Example 7 | | 100 | | | 0.005 | | 29 | 5.4 |
| Example 8 | 2EHA/2MEA/ | 100 | | 0.30 | | | 40 | 4.5 |
| | NVP/HEAA | | | | | | | |
| | 68/24/6/2 | | | | | | | |
| Example 9 | 2EHA/2MEA/ | 100 | 0.05 | | | | 35 | 6.8 |
| | 4HBA | | | | | | | |
| Example 10 | 69/30/1 | 100 | 0.10 | | | | 53 | 4.5 |
| Example 11 | 2EHA/2MEA/ | 100 | | 0.30 | | | 65 | 5.0 |
| | NVP/HEAA | | | | | | | |
| | 80/11.5/7/1.5 | | | | | | | |
| Comparative | 2EHA/2MEA/ | 100 | 0.05 | | | | 35 | 2.1 |
| Example 2 | 4HBA | | | | | | | |
| | 40/59/1 | | | | | | | |
| Comparative | | 100 | 0.10 | | | | 50 | 3 |
| Example 3 | | | | | | | | |
| Comparative | 2EHA/NVP/ | 100 | 0.05 | | | | 53 | 7 |
| Example 4 | HEAA | | | | | | | |
| | 70/26/4 | | | | | | | |

| | PHYSICAL | | | | | |
|---|---|---|---|---|---|---|
| | PROPERTIES | | | | | |
| | 180° | | | | | |
| | peeling | | | | | |
| | pressure- | | | | | |
| | sensitive | | | | | |
| | adhesive | | | | | |
| | force (vs | Storage | Loss | 300% | | |
| | acrylic | modulus | modulus | tensile | Residual | |
| | plate) | (23° C.) | (23° C.) | stress | stress | |
| | (N/25 mm) | (Pa) | (Pa) | (N/cm²) | (N/cm²) | |
| | | | | | | Evaluation |
| | | | | | | Foaming/ |
| | | | | | | peeling |
| | | | | | | resistance |
| Example 1 | 35.0 | 7.1 × 10⁴ | 1.6 × 10⁴ | 4.2 | 0.9 | Good |
| Example 2 | 34.4 | 7.3 × 10⁴ | 1.7 × 10⁴ | 3.8 | 1.5 | Good |
| Example 3 | 30.4 | 7.3 × 10⁴ | 1.6 × 10⁴ | 3.9 | 1.7 | Good |
| Comparative | 32.7 | 6.9 × 10⁴ | 1.6 × 10⁴ | 3.8 | 1.5 | Good |
| Example 1 | | | | | | |
| Example 4 | 26.6 | 9.0 × 10⁴ | 1.9 × 10⁴ | 5.9 | 3.0 | Good |
| Example 5 | 29.6 | 8.9 × 10⁴ | 2.0 × 10⁴ | 5.6 | 2.7 | Good |
| Example 6 | 21.3 | 8.6 × 10⁴ | 1.8 × 10⁴ | 5.7 | 2.8 | Good |
| Example 7 | 23.0 | 8.5 × 10⁴ | 1.8 × 10⁴ | 5.9 | 2.6 | Good |
| Example 8 | 20 | 8.8 × 10⁴ | 2.3 × 10⁴ | 3.7 | 1.2 | Good |
| | | | | | | Evaluation |
| | | | | | | Foaming |
| | | | | | | and |
| | | | | | | peeling |
| | | | | | | resistance |
| Example 9 | 15.5 | 7.1 × 10⁴ | 1.8 × 10⁴ | 3.7 | 1.3 | Good |
| Example 10 | 14.25 | 7.1 × 10⁴ | 1.8 × 10⁴ | 2.7 | 1.2 | Good |
| Example 11 | 20 | 7.1 × 10⁴ | 2.0 × 10⁴ | 5.0 | 2.5 | Good |
| Comparative | 20.6 | 1.1 × 10⁵ | 2.4 × 10⁴ | 5.1 | 2.0 | Good |
| Example 2 | | | | | | |
| Comparative | 18.2 | 1.1 × 10⁵ | 2.4 × 10⁴ | 5.4 | 2.5 | Good |
| Example 3 | | | | | | |
| Comparative | 16.8 | 4.0 × 10⁵ | 3.3 × 10⁵ | 24.2 | 13.3 | Good |
| Example 4 | | | | | | |

While the present invention has been described in detail and with reference to specific embodiments thereof, it will be apparent to one skilled in the art that various changes and modifications can be made therein without departing from the scope thereof.

This application is based on Japanese patent application No. 2009-035058 filed Feb. 18, 2009, the entire contents thereof being hereby incorporated by reference.

What is claimed is:

1. A double-sided pressure-sensitive adhesive sheet, comprising at least one pressure-sensitive adhesive layer which has a gel fraction of 10 to 70%, has a storage modulus at 23° C. of 1×10⁵ Pa or less, and has a residual stress after 180 seconds of 3.5 N/cm² or less, the storage modulus at 23° C. being measured in accordance with a dynamic viscoelasticity measurement and the residual stress after 180 seconds being measured in accordance with a tensile stress relaxation test under conditions of a temperature of 23° C. and a strain of 300%.

2. The double-sided pressure-sensitive adhesive sheet according to claim 1, wherein the pressure-sensitive adhesive layer is an acrylic pressure-sensitive adhesive layer.

3. The double-sided pressure-sensitive adhesive sheet according to claim 2, wherein the acrylic pressure-sensitive adhesive layer is an acrylic pressure-sensitive adhesive layer formed using a (meth)acrylic acid alkyl ester and an acrylic acid alkoxyalkyl ester as essential monomer components.

4. The double-sided pressure-sensitive adhesive sheet according to claim 3, wherein the acrylic pressure-sensitive adhesive layer is an acrylic pressure-sensitive adhesive layer formed by irradiating with an active energy ray a composition containing a monomer mixture containing a (meth)acrylic acid alkyl ester and an acrylic acid alkoxyalkyl ester as essential monomer components or a partial polymerization product thereof, and wherein the monomer mixture contains the acrylic acid alkoxyalkyl ester in an amount of 10 to 45% by weight.

5. The double-sided pressure-sensitive adhesive sheet according to claim 1, which is a substrate-less double-sided pressure-sensitive adhesive sheet consisting of the pressure-sensitive adhesive layer.

6. The double-sided pressure-sensitive adhesive sheet according to claim 1, which has a total thickness of 50 to 600 μm.

7. A pressure-sensitive adhesive type optical member, which comprises an optical member and the double-sided pressure-sensitive adhesive sheet according to claim 1 laminated on a surface of the optical member.
